(19) United States
(12) Patent Application Publication
(10) Pub. No.: US 2025/0351112 A1
(43) Pub. Date: Nov. 13, 2025

(54) SIGNALING FOR SIDELINK POSITIONING

(71) Applicant: QUALCOMM Incorporated, San Diego, CA (US)

(72) Inventors: Alexandros MANOLAKOS, Athens (GR); Mukesh KUMAR, Hyderabad (IN); Srinivas YERRAMALLI, San Diego, CA (US)

(21) Appl. No.: 18/871,141

(22) PCT Filed: Jun. 30, 2023
(86) PCT No.: PCT/US2023/026732

§ 371 Date: Dec. 2, 2024

(30) Foreign Application Priority Data
Jul. 28, 2022 (GR) 20220100613

(51) Int. Cl. H04W 64/00; H04B 17/318; H04W 8/22; H04W 92/18

(52) U.S. Cl. CPC H04W 64/00; H04B 17/328; H04W 8/22; H04W 92/18

(57) ABSTRACT

Apparatus, methods, and computer program products for providing sidelink UE information are provided. An example method may include receiving at least one system information block (SIB) from a network entity, the at least one SIB including a sidelink data configuration associated with a data transmission and a sidelink positioning configuration associated with a positioning session. The example method may further include transmitting sidelink UE information to the network entity, the sidelink UE information including an indication of at least one of: a failure associated with the sidelink positioning configuration, a request for transmission (Tx) sidelink resources for the positioning session, or a list of reception (Rx) sidelink resources for the positioning session.

### CROSS-REFERENCE TO RELATED APPLICATION

This application claims the benefit of Greece Patent Application Serial No. 20220100613, entitled “SIGNALING FOR SIDELINK POSITIONING” and filed on Jul. 28, 2022, which is expressly incorporated by reference herein in its entirety.

### TECHNICAL FIELD

The present disclosure relates generally to communication systems, and more particularly, to wireless communication systems with sidelink positioning.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus at a user equipment (UE) are provided. The apparatus may include a memory and at least one processor coupled to the memory. The memory and the at least one processor coupled to the memory may be configured to receive at least one system information block (SIB) from a network entity, the at least one SIB including a sidelink data configuration associated with a data transmission and a sidelink positioning configuration associated with a positioning session. The memory and the at least one processor coupled to the memory may be further configured to transmit sidelink UE information to the network entity, the sidelink UE information including an indication of at least one of: a failure associated with the sidelink positioning configuration, a request for transmission (Tx) sidelink resources for the positioning session, or a list of reception (Rx) sidelink resources for the positioning session.

In another aspect of the disclosure, a method, a computer-readable medium, and an apparatus at a network entity are provided. The apparatus may include a memory and at least one processor coupled to the memory. The memory and the at least one processor coupled to the memory may be configured to transmit at least one system information block (SIB) to a user equipment (UE), the at least one SIB including a sidelink data configuration associated with a data transmission and a sidelink positioning configuration associated with a positioning session. The memory and the at least one processor coupled to the memory may be further configured to receive sidelink UE information from the UE, the sidelink UE information including an indication of at least one of: a failure associated with the sidelink positioning configuration, a request for transmission (Tx) sidelink resources for the positioning session, or a list of reception (Rx) sidelink resources for the positioning session.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 is a diagram illustrating an example of a UE positioning based on reference signal measurements.

FIG. 5A is a diagram illustrating an example of positioning.

FIG. 5B is a diagram illustrating an example of positioning.

FIG. 5C is a diagram illustrating an example of positioning.

FIG. 6A is a diagram illustrating an example of pos-peer selection procedures of SL cooperative positioning.

FIG. 6B is a diagram illustrating an example of pos-peer selection procedures of SL cooperative positioning.

FIG. 7 is a diagram illustrating an example of sidelink positioning reference signal (PRS) configuration and resource pool (RP) for positioning (RP-P) configuration.

FIG. 8A is a diagram illustrating example communications between a network entity and a UE.

FIG. 8B is a diagram illustrating example communications between a network entity and a UE.

FIG. 9 is a flowchart of a method of wireless communication.

FIG. 10 is a flowchart of a method of wireless communication.

FIG. 11 is a diagram illustrating an example of a hardware implementation for an example apparatus and/or network entity.

FIG. 12 is a diagram illustrating an example of a hardware implementation for an example network entity.

### DETAILED DESCRIPTION

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

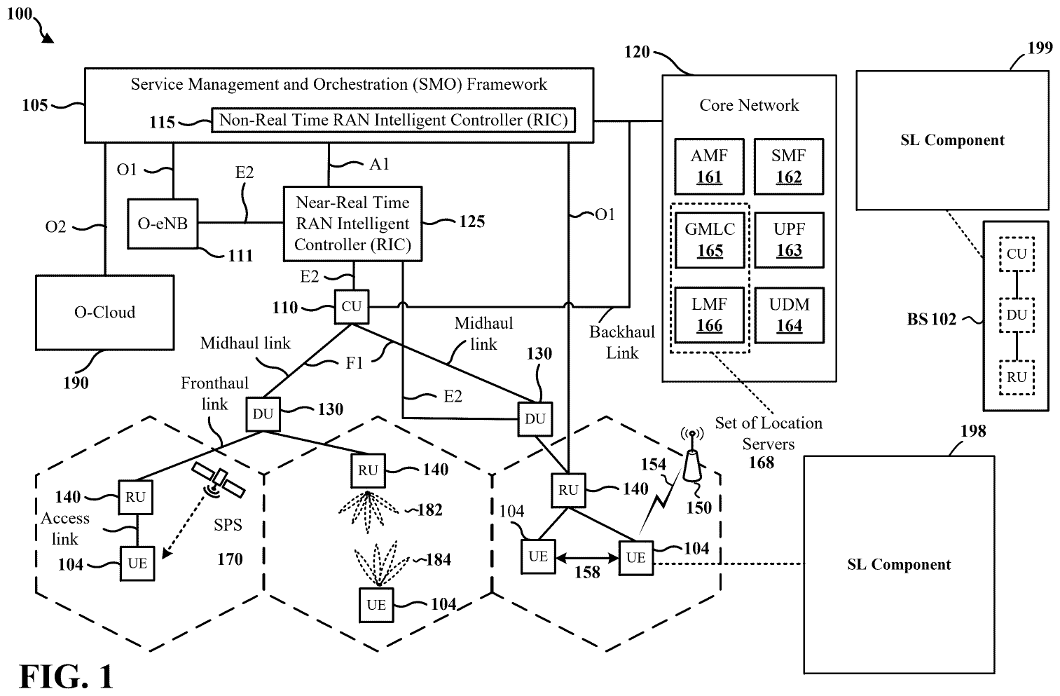

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU.

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in some aspects, the UE 104 may include an SL component 198. In some aspects, the SL component 198 may be configured to receive at least one system information block (SIB) from a network entity, the at least one SIB including a sidelink data configuration associated with a data transmission and a sidelink positioning configuration associated with a positioning session. In some aspects, the SL component 198 may be further configured to transmit sidelink UE information to the network entity, the sidelink UE information including an indication of at least one of: a failure associated with the sidelink positioning configuration, a request for transmission (Tx) sidelink resources for the positioning session, or a list of reception (Rx) sidelink resources for the positioning session.

In certain aspects, the base station 102 may include an SL component 199. In some aspects, the SL component 199 may be configured to transmit at least one system information block (SIB) to a user equipment (UE), the at least one SIB including a sidelink data configuration associated with a data transmission and a sidelink positioning configuration associated with a positioning session. In some aspects, the SL component 199 may be further configured to receive sidelink UE information from the UE, the sidelink UE information including an indication of at least one of: a failure associated with the sidelink positioning configuration, a request for transmission (Tx) sidelink resources for the positioning session, or a list of reception (Rx) sidelink resources for the positioning session.

Although the following description may be focused on 5G NR, the concepts described herein may be applicable to other similar areas, such as LTE, LTE-A, CDMA, GSM, and other wireless technologies.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

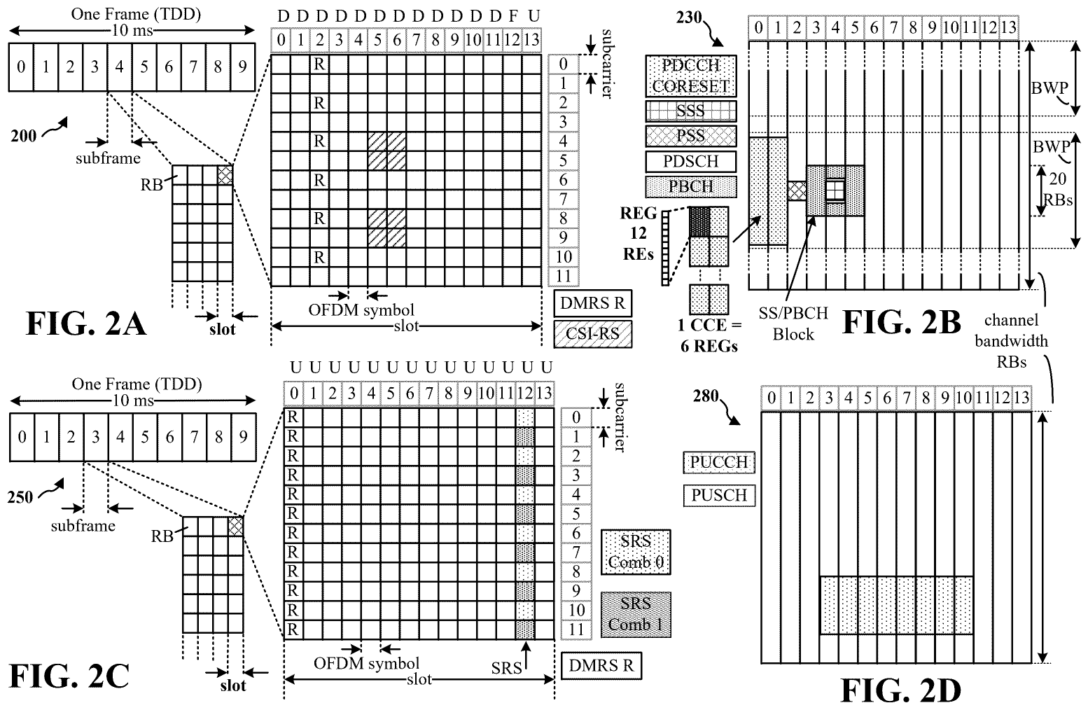

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI).

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |

For normal CP (14 symbols/slot), different numerologies μ0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

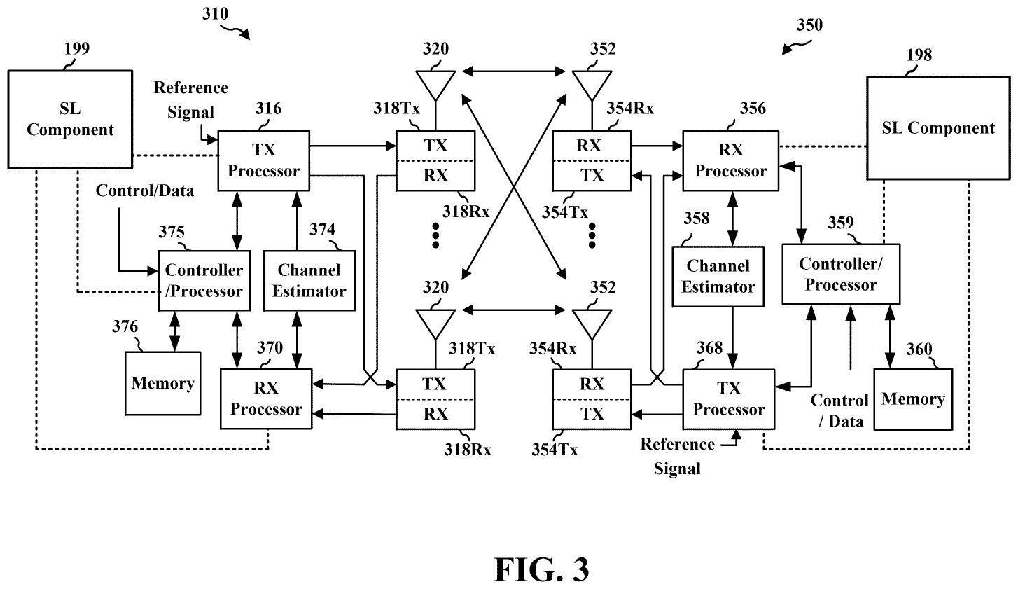

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with SL component 198 of FIG. 1.

At least one of the TX processor 316, the RX processor 370, and the controller/processor 375 may be configured to perform aspects in connection with SL component 199 of FIG. 1.

As used herein, the term “sidelink data configuration” may refer to a sidelink communication configuration for data transmission on a sidelink between two UEs. As used herein, the term “sidelink positioning configuration” may refer to a sidelink communication configuration for positioning based on a sidelink between two UEs.

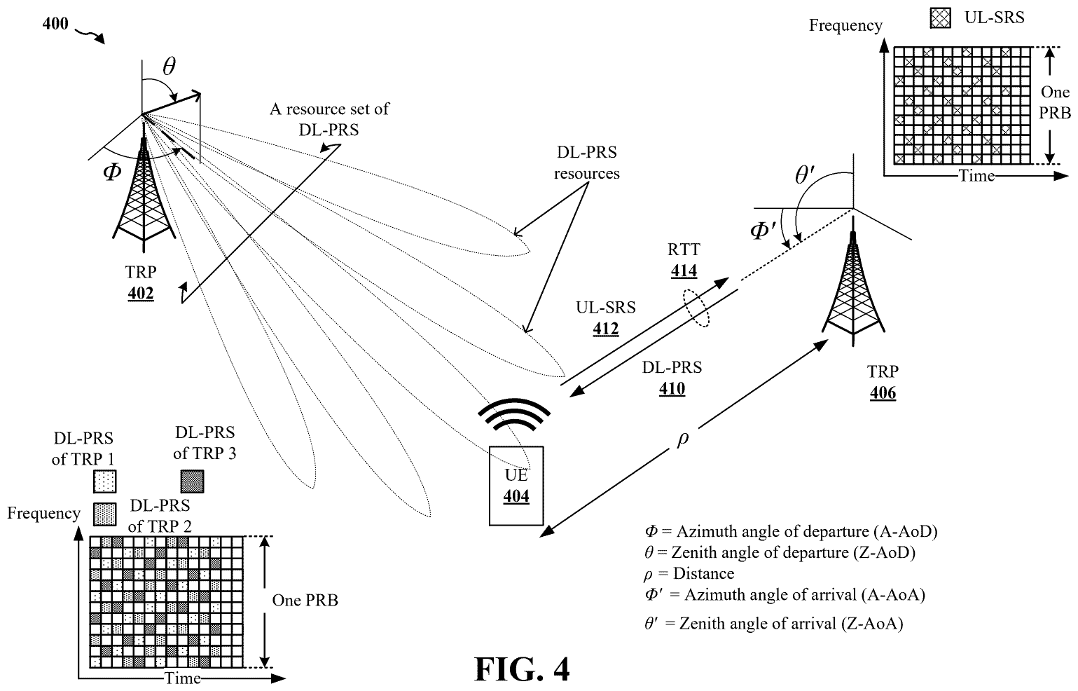

FIG. 4 is a diagram 400 illustrating an example of a UE positioning based on reference signal measurements. The UE 404 may transmit UL-SRS 412 at time T_{SRS_TX} and receive DL positioning reference signals (PRS) (DL-PRS) 410 at time T_{PRS_RX}. The TRP 406 may receive the UL-SRS 412 at time T_{SRS_RX} and transmit the DL-PRS 410 at time T_{PRS_TX}. The UE 404 may receive the DL-PRS 410 before transmitting the UL-SRS 412, or may transmit the UL-SRS 412 before receiving the DL-PRS 410. In both cases, a positioning server (e.g., location server(s) 168) or the UE 404 may determine the RTT 414 based on ∥T_{SRS_RX}−T_{PRS_TX}|−|T_{SRS_TX}−T_{PRS_RX}∥. Accordingly, multi-RTT positioning may make use of the UE Rx-Tx time difference measurements (i.e., |T_{SRS_TX}−T_{PRS_RX}|) and DL-PRS reference signal received power (RSRP) (DL-PRS-RSRP) of downlink signals received from multiple TRPs 402, 406 and measured by the UE 404, and the measured TRP Rx-Tx time difference measurements (i.e., |T_{SRS_RX}−T_{PRS_TX}|) and UL-SRS-RSRP at multiple TRPs 402, 406 of uplink signals transmitted from UE 404. The UE 404 measures the UE Rx-Tx time difference measurements (and optionally DL-PRS-RSRP of the received signals) using assistance data received from the positioning server, and the TRPs 402, 406 measure the gNB Rx-Tx time difference measurements (and optionally UL-SRS-RSRP of the received signals) using assistance data received from the positioning server. The measurements may be used at the positioning server or the UE 404 to determine the RTT, which is used to estimate the location of the UE 404. Other methods are possible for determining the RTT, such as for example using DL-TDOA and/or UL-TDOA measurements.

DL-AoD positioning may make use of the measured DL-PRS-RSRP of downlink signals received from multiple TRPs 402, 406 at the UE 404. The UE 404 measures the DL-PRS-RSRP of the received signals using assistance data received from the positioning server, and the resulting measurements are used along with the azimuth angle of departure (A-AoD), the zenith angle of departure (Z-AoD), and other configuration information to locate the UE 404 in relation to the neighboring TRPs 402, 406.

DL-TDOA positioning may make use of the DL reference signal time difference (RSTD) (and optionally DL-PRS-RSRP) of downlink signals received from multiple TRPs 402, 406 at the UE 404. The UE 404 measures the DL RSTD (and optionally DL-PRS-RSRP) of the received signals using assistance data received from the positioning server, and the resulting measurements are used along with other configuration information to locate the UE 404 in relation to the neighboring TRPs 402, 406.

UL-TDOA positioning may make use of the UL relative time of arrival (RTOA) (and optionally UL-SRS-RSRP) at multiple TRPs 402, 406 of uplink signals transmitted from UE 404. The TRPs 402, 406 measure the UL-RTOA (and optionally UL-SRS-RSRP) of the received signals using assistance data received from the positioning server, and the resulting measurements are used along with other configuration information to estimate the location of the UE 404.

UL-AoA positioning may make use of the measured azimuth angle of arrival (A-AoA) and zenith angle of arrival (Z-AoA) at multiple TRPs 402, 406 of uplink signals transmitted from the UE 404. The TRPs 402, 406 measure the A-AoA and the Z-AoA of the received signals using assistance data received from the positioning server, and the resulting measurements are used along with other configuration information to estimate the location of the UE 404.

Additional positioning methods may be used for estimating the location of the UE 404, such as for example, UE-side UL-AoD and/or DL-AoA. Note that data/measurements from various technologies may be combined in various ways to increase accuracy, to determine and/or to enhance certainty, to supplement/complement measurements, and/or to substitute/provide for missing information.

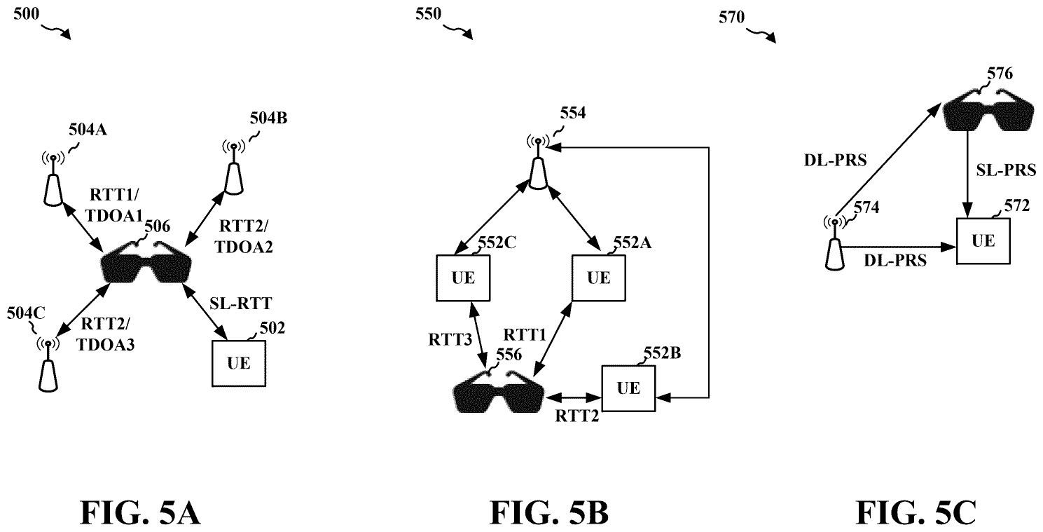

Positioning may be based on sidelink between UEs, access link between network entity and UE, or based jointly on access link and sidelink. FIG. 5A is a diagram 500 illustrating an example of positioning. As illustrated in FIG. 5A, for positioning related to a wireless device 506, a first network entity 504A, a second network entity 504B, and a third network entity 504C may be involved and may each be associated with a respective RTT or TDOA that may be measured. To further improve accuracy of position related to the wireless device 506, a UE 502 (that may be associated with a location known to the network) may serve as an extra anchor for the positioning of the wireless device 506. A sidelink RTT between the UE 502 and the wireless device 506 may be measured. In the diagram 500, sidelink positioning and access link positioning may be used jointly.

FIG. 5B is a diagram 550 illustrating an example of positioning. As illustrated in FIG. 5B, for positioning related to a wireless device 556, a first UE 552A, a second UE 552B, and a third UE 552C may be involved and may each be associated with a respective RTT that may be measured. In the diagram 550, sidelink positioning may be used. Each of the first UE 552A, the second UE 552B, and the third UE 552C may be in communication with a network entity 554.

FIG. 5C is a diagram 570 illustrating an example of positioning. As illustrated in FIG. 5C, for positioning of a UE 572, a network entity 574 may transmit PRS to the UE 572. If the PRS cannot be directly transmitted from the network entity 574 to the UE 572 (such as when the UE 572 is out of coverage), the network entity 574 may transmit the PRS to a wireless device 576 and the wireless device 576 may relay the PRS to the UE 572.

Sidelink communication may include direct wireless communication between a first device (e.g., a first UE or other sidelink device) and a second device (e.g., a second UE or other sidelink device), e.g., without being routed by a base station. In a first mode, a UE may receive a resource allocation for sidelink communication from the base station. The sidelink resource allocation from a base station may be referred to as “resource allocation mode 1” or a “centralized” resource allocation mode, e.g., in which a network entity allocates sidelink resources for multiple sidelink devices. Before exchanging communication, sidelink devices may perform a discovery procedure to discover each other. In some wireless communication systems, such as for communication systems supporting mode 2 resource allocation, the discovery procedure may include a first UE (that may be referred to as an announcing UE) that broadcasts the announcement message that is received by a second UE (that may be referred to as a monitoring UE). The discovery procedure, in which the announcing UE broadcasts an announcement message to one or more monitoring UEs, may be referred as mode A sidelink discovery. In another type of discovery procedure, a first UE (that may be referred to as a discoverer UE) sends a solicitation message including a discovery request and a second UE (that may be referred to as a discoveree UE) may receive the request and send a response message. The discovery procedure, in which the discoverer UE transmits a solicitation message including a discovery request to one or more discoveree UEs, may be referred as mode B sidelink discovery.

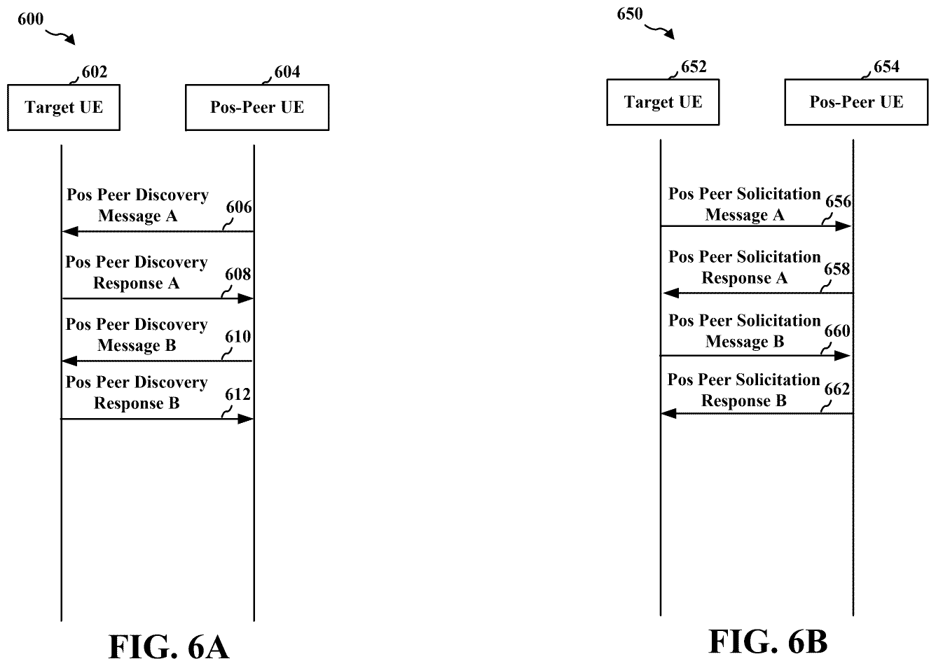

To discover a pos-peer (which may be a peer SL UE for performing positioning), in mode A, a pos-peer UE may announce its presence through transmitting a SL-Pos discovery message with a positioning flag. In mode B, a target UE that wants to discover Pos-Peer UEs may initiate with a SL-Pos solicitation message with field(s) related to positioning. FIG. 6A is a diagram 600 illustrating an example of pos-peer selection procedures of SL cooperative positioning in mode A. As illustrated in FIG. 6A, a pos-peer UE 604 may transmit a pos-peer discovery message A 606 to a target UE 602. Upon receiving the pos-peer discovery message A 606, the target UE 602 may transmit a pos-peer discovery response A 608 to the pos-peer UE 604. The pos-peer UE 604 may also transmit a pos-peer discovery message B 610 to the target UE 602. Upon receiving the pos-peer discovery message B 610, the target UE 602 may transmit a pos-peer discovery response B 612 to the pos-peer UE 604 to complete the discovery process, and sidelink positioning may be performed between the target UE 602 and the pos-peer UE 604.

FIG. 6B is a diagram 650 illustrating an example of pos-peer selection procedures of SL cooperative positioning in mode B. As illustrated in FIG. 6B, a target UE 652 may transmit a pos-peer solicitation message A 656 to a pos-peer UE 654. Upon receiving the pos-peer solicitation message A 656, the pos-peer UE 654 may transmit a pos-peer solicitation response message A 658 to the target UE 652. The target UE 652 may also transmit a pos-peer solicitation message B 660 to the pos-peer UE 654. Upon receiving the pos-peer solicitation message B 660, the pos-peer UE 654 may transmit a pos-peer solicitation response message B 662 to the target UE 652 to complete the discovery process, and sidelink positioning may be performed between the target UE 652 and the pos-peer UE 654.

Both sidelink positioning discovery and solicitation messages can be split in 2 parts to enable a more power efficient approach and a handshake between the target UEs and the potential pos-peer UEs. A target UE may rank potential pos-peer UEs based on one or more of: anchor's Location quality criterion, channel quality criterion, response time criterion, or mobility state criterion.

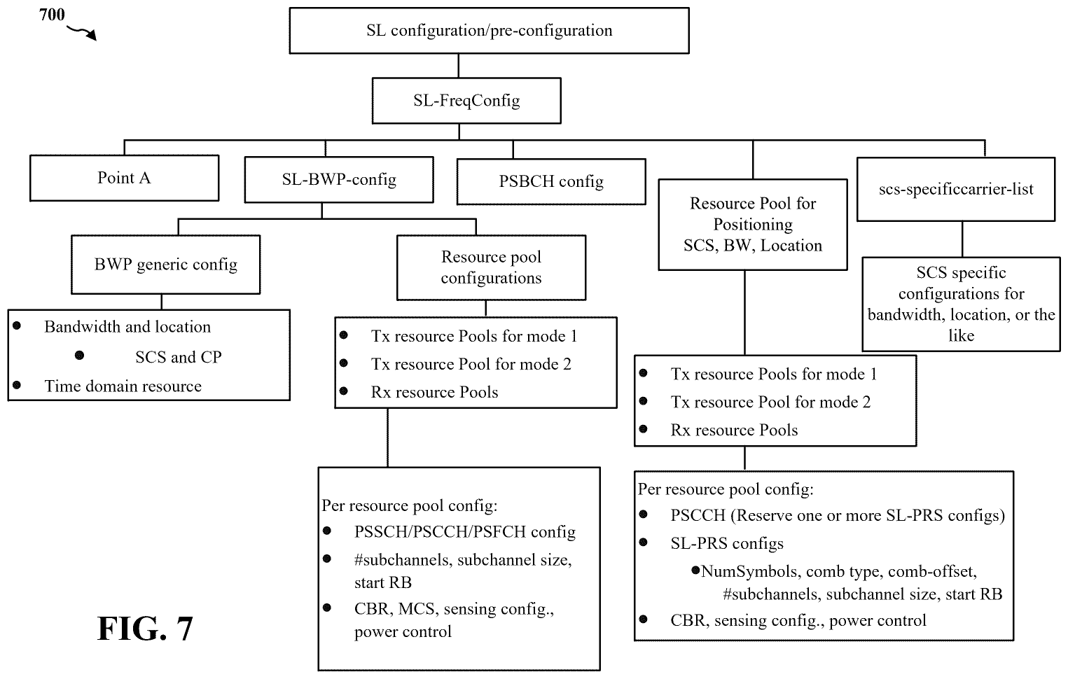

FIG. 7 is a diagram 700 illustrating an example of sidelink positioning reference signal (PRS) configuration and resource pool (RP) for positioning (RP-P) configuration. As illustrated in FIG. 7, in some wireless communication systems, a sidelink communication configuration (such as a sidelink positioning configuration, a sidelink data configuration, or a configuration used jointly for data and positioning) may include a SL frequency configuration and may be associated with a Point A (which may be a common reference point for resource block grids and may be represented by a frequency offset between Point A and a lowest subcarrier of the lowest resource block of the SS/PBCH block used by the UE for initial cell selection or an absolute frequency), a SL bandwidth part (BWP) configuration, a PSBCH configuration, a resource pool for positioning, SCS, BW, location, or the like, or a SCS carrier list. The SCS carrier list may be associated with SCS specific configurations for bandwidth, location, or the like.

In some aspects, The SL BWP configuration may be associated with Tx resource pools for mode 1 (mode A), Tx resource pools for mode 2 (mode B), and Rx resource pools. In some aspects, per resource pool configurations may be provided. The per resource pool configurations may include PSSCH/PSCCH/PSFCH configurations, subchannel number, size, or starting RB, and channel busy ratio (CBR), modulation and coding scheme (MCS), sensing configuration, or power control configurations.

In some aspects, the resource pool for positioning, SCS, BW, location, or the like may be associated with Tx resource pools for mode 1 (mode A), Tx resource pools for mode 2 (mode B), and Rx resource pools. In some aspects, per resource pool configurations may be provided. The per resource pool configurations may include PSCCH or SL-PRS configurations (e.g., including number of symbols, comb type, comb offset, number of subchannels, subchannel size, subchannel starting RB, or the like), CBR, MCS, sensing configuration, or power control configurations.

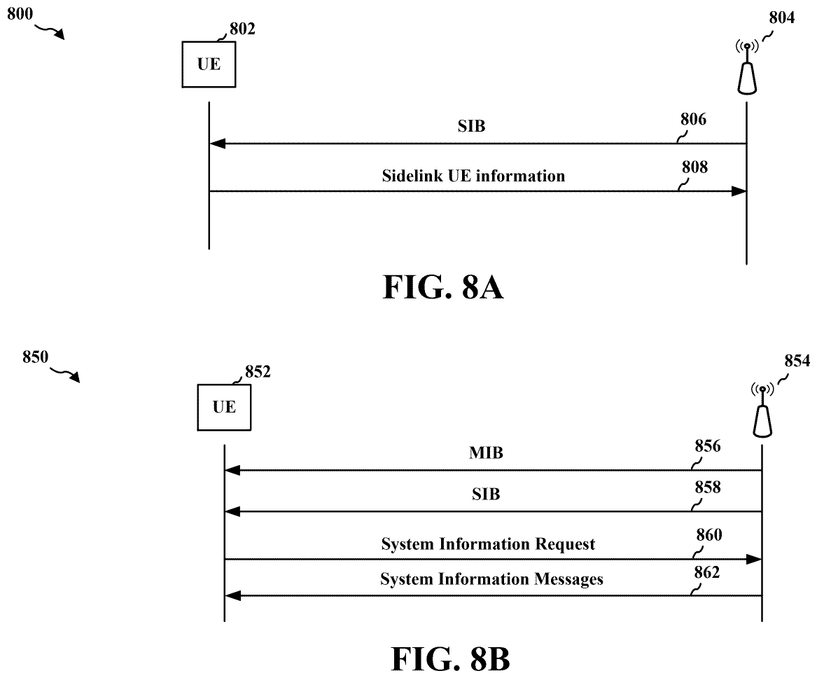

FIG. 8A is a diagram 800 illustrating example communications between a network entity 804 and a UE 802. In some aspects, the network entity 804 may be implemented as an aggregated base station, a disaggregated base station, an integrated access and backhaul (IAB) node, a relay node, a sidelink node, or the like. In some aspects, the network entity 804 may be implemented in an aggregated or monolithic base station architecture, or alternatively, in a disaggregated base station architecture, and may include one or more of a CU, a DU, a RU, a Near-Real Time (Near-RT) RAN Intelligent Controller (RIC), or a Non-Real Time (Non-RT) RIC. As illustrated in FIG. 8A, the network entity 804 may transmit SIB 806 to the UE 802. A SIB may be of different types such as SIB type 1 for cell selection, cell access and system information (SI) scheduling, type 2 for random access, access barring, UL frequency information, and multimedia broadcast multicast service single frequency network configuration, type 3 for intra frequency cell reselection, type 4 for intra frequency neighbor cell, type 5 for inter frequency neighbor cell, and other types. The SIB 806 may be SIB type 12 for carrying a sidelink communication configuration. Upon receiving the SIB 806 of SIB type 12, the UE 802 may discard stored segments (if present) of previous SIB 12 and store the SIB 806 and assemble one or more information elements (IEs) based on the SIB 806. If SL frequency list is present, the UE 802 may use the resources pools indicated by the SL frequency list for sidelink communication reception or sidelink communication transmission. The UE 802 may also perform CBR measurements based on transmission resources pools indicated by the SIB 806. The UE 802 may also perform sidelink DRB addition/modification/release based on SL communication configurations in the SIB 806. The UE 802 may also store sidelink measurement configuration in the based on SL communication configurations in the SIB 806. In some aspects, the SL communication configurations may include separate configurations for the UE 802, such as sidelink data configurations for data communication for the UE 802 and sidelink positioning configurations for the UE 802.

The UE 802 may transmit sidelink UE information 808 to the network entity 804. The sidelink UE information 808 may be used to inform the network that the UE 802 may be: 1) interested or no longer interested to receive or transmit sidelink communication, 2) requesting assignment or release of transmission resource for sidelink communication, 3) reporting quality of service (QoS) parameters and QoS profile(s) related to sidelink communication, 4) reporting that a sidelink radio link failure or sidelink RRC reconfiguration failure has been detected, 5) reporting the sidelink UE capability information of the associated peer UE for unicast communication, 6) reporting the RLC mode information of the sidelink data radio bearer(s) received from the associated peer UE for unicast communication.

In some wireless communication systems, the sidelink UE information may report failure associated with SL data communications and positioning jointly and there may be no way to distinguish failures associated with SL data communications and failures associated with positioning. Therefore, a joint failure may be reported even if one of the SL data communication or the positioning has not failed yet, which may cause configurations for the SL data communication and the positioning to be reconfigured. Example aspects provided herein may enable separate indication of failure for SL data communication and positioning, which may enable configurations for the SL data communication and the positioning to be reconfigured separately upon failure, resulting in more efficient configuration. An example sidelink UE information may be provided below:

-- ASN1START
-- TAG-SIDELINKUEINFORMATIONNR-START

| | |
|---|---|
| SidelinkUEInformationNR-r16::= | SEQUENCE { |
| criticalExtensions | CHOICE { |
| sidelinkUEInformationNR-r16 | SidelinkUEInformationNR-r16-IEs, |
| criticalExtensionsFuture | SEQUENCE { } |

}
}

| SidelinkUEInformationNR-r16-IEs ::= | SEQUENCE { | |
|---|---|---|
| sl-RxInterestedFreqList-r16 | SL-InterestedFreqList-r16 | OPTIONAL, |
| sl-TxResourceReqList-r16 | SL-TxResourceReqList-r16 | OPTIONAL, |
| sl-FailureList-r16 | SL-FailureList-r16 | OPTIONAL, |
| lateNonCriticalExtension | OCTET STRING | OPTIONAL, |
| nonCriticalExtension | SEQUENCE { } | OPTIONAL |

}

| | |
|---|---|
| SL-FailureList-r16 ::= | SEQUENCE (SIZE (1..maxNrofSL-Dest-r16)) OF SL- |

Failure-r16

| | |
|---|---|
| SL-Failure-r16 ::= | SEQUENCE { |
| sl-DestinationIdentity-r16 | SL-DestinationIdentity-r16, |
| sl-Failure-r16 | ENUMERATED {rlf, configFailure, spare6, spare5, |

spare4, spare3, spare2, spare1}
}

The IE sl-RxInterestedFreqList may indicate the index of frequency on which the UE is interested to receive NR sidelink communication. The value 1 corresponds to the frequency of first entry in sl-FreqInfoList broadcast in SIB12, the value 2 corresponds to the frequency of second entry in sl-FreqInfoList broadcast in SIB12 and so on. In this release, only value 1 can be included in the interested frequency list. The IE sl-TxResourceReq may be parameters to request the transmission resources for sidelink communication to the network in the sidelink UE information. Each entry in the IE sl-TxInterestedFreqList may indicate the index of frequency on which the UE is interested to transmit sidelink communication. The value 1 may correspond to the frequency of first entry in sl-FreqInfoList broadcast in SIB12, the value 2 may correspond to the frequency of second entry in sl-FreqInfoList broadcast in SIB12 and so on. The IE sl-FailureList may represent failures. In some aspects, in the IE sl-FailureList, failures associated with sidelink positioning configuration and failures associated with sidelink data configuration may be separately indicated.

Another example sidelink UE information is provided below:

| SidelinkUEInformationNR-r16-IEs ::= | SEQUENCE { | |
|---|---|---|
| sl-RxInterestedFreqList-r16 | SL-InterestedFreqList-r16 | OPTIONAL, |
| sl-TxResourceReqList-r16 | SL-TxResourceReqList-r16 | OPTIONAL, |
| sl-FailureList-r16 | SL-FailureList-r16 | OPTIONAL, |
| lateNonCriticalExtension | OCTET STRING | OPTIONAL, |
| nonCriticalExtension | SEQUENCE { } | OPTIONAL |

}

| | |
|---|---|
| SL-InterestedFreqList-r16 ::= | SEQUENCE (SIZE (1..maxNrofFreqSL-r16)) OF |

INTEGER (1..maxNrofFreqSL-r16)

| | |
|---|---|
| SL-TxResourceReqList-r16 ::= | SEQUENCE (SIZE (1..maxNrofSL-Dest-r16)) |

OF SL-TxResourceReq-r16

| | |
|---|---|
| SL-TxResourceReq-r16 ::= | SEQUENCE { |
| sl-DestinationIdentity-r16 | SL-DestinationIdentity-r16, |
| sl-CastType-r16 | ENUMERATED {broadcast, groupcast, unicast, |

spare1},

| | |
|---|---|
| sl-RLC-ModeIndicationList-r16 | SEQUENCE (SIZE (1.. maxNrofSLRB-r16)) |
| OF SL-RLC-ModeIndication-r16 | OPTIONAL, |
| sl-QoS-InfoList-r16 | SEQUENCE (SIZE (1..maxNrofSL-QFIsPerDest- |
| r16)) OF SL-QoS-Info-r16 | OPTIONAL, |
| sl-TypeTxSyncList-r16 | SEQUENCE (SIZE (1..maxNrofFreqSL-r16)) OF |
| SL-TypeTxSync-r16 | OPTIONAL, |
| sl-TxInterestedFreqList-r16 | SL-TxInterestedFreqList-r16 |

OPTIONAL,

| | |
|---|---|
| sl-CapabilityInformationSidelink-r16 | OCTET STRING |

OPTIONAL
}

| | |
|---|---|
| SL-TxInterestedFreqList-r16 ::= | SEQUENCE (SIZE (1..maxNrofFreqSL-r16)) OF |

INTEGER (1..maxNrofFreqSL-r16)
-- TAG-SIDELINKUEINFORMATIONNR-STOP
-- ASN1STOP

The IE sl-RxInterestedFreqList may indicate the index of frequency on which the UE is interested to receive sidelink communication. The value 1 corresponds to the frequency of first entry in sl-FreqInfoList broadcast in SIB12, the value 2 corresponds to the frequency of second entry in sl-FreqInfoList broadcast in SIB12 and so on. In this release, only value 1 can be included in the interested frequency list. The IE sl-TxResourceReq may be parameters to request the transmission resources for sidelink communication to the network in the sidelink UE information. Each entry in the IE sl-TxInterestedFreqList may indicate the index of frequency on which the UE is interested to transmit sidelink communication. The value 1 may correspond to the frequency of first entry in sl-FreqInfoList broadcast in SIB12, the value 2 may correspond to the frequency of second entry in sl-FreqInfoList broadcast in SIB12 and so on. The IE sl-CapabilityInformationSidelink may include the UECapabilityInformationSidelink message (which can be also included in ueCapabilityInformationSidelink-r16 in UECapabilityEnquirySidelink from peer UE) received from the peer UE. The IE sl-CastType may indicate the cast type for the corresponding destination for which to request the resource. The IE sl-DestinationIdentity may indicate the destination for which the TX resource request and allocation from the network are concerned. The IE sl-QoS-InfoList may include the QoS profile of the sidelink QoS flow. The IE sl-QoS-FlowIdentity may uniquely identify one sidelink QoS flow between the UE and the network in the scope of UE, which is unique for different destination and cast type. The IE sl-RLC-ModeIndication may indicate the RLC mode and optionally the related QoS profiles for the sidelink radio bearer, which has not been configured by the network and may be initiated by another UE in unicast. The RLC mode for one sidelink radio bearer may be aligned between UE and network by the sl-QoS-FlowIdentity. The IE sl-TypeTxSyncList may represent a list of synchronization reference used by the UE. In some aspects, the example sidelink UE information may also include a sl-PosRxInterestedFreqList IE representing index of frequency on which the UE is interested to receive sidelink communication for positioning. The value 1 may correspond to the frequency of first entry in sl-FreqInfoList broadcast in SIB12, the value 2 may correspond to the frequency of second entry in sl-FreqInfoList broadcast in SIB12 and so on. The sidelink UE information may also include a sl-PosTxResourceReqList associated with resources or parameters for requesting the transmission resources for sidelink communication for positioning. In other words, in some aspects, the sidelink UE information 808 may include interested or requested resources associated with sidelink communication for positioning, which may be separate from interested or requested resources associated with other sidelink communications.

An example SIB 12 for providing sidelink communication configuration is provided below:

-- ASN1START
-- TAG-SIB12-START

| | |
|---|---|
| SIB12-r16 ::= | SEQUENCE { |
| segmentNumber-r16 | INTEGER (0..63), |
| segmentType-r16 | ENUMERATED {notLastSegment, lastSegment}, |
| segmentContainer-r16 | OCTET STRING |

}

| SIB12-IEs-r16 ::= | SEQUENCE { | |
|---|---|---|
| sl-ConfigCommonNR-r16 | SL-ConfigCommonNR-r16, | |
| lateNonCriticalExtension | OCTET STRING | OPTIONAL, |

...
}

| | |
|---|---|
| SL-ConfigCommonNR-r16 ::= | SEQUENCE { |
| sl-FreqInfoList-r16 | SEQUENCE (SIZE (1..maxNrofFreqSL-r16)) OF SL- |
| FreqConfigCommon-r16 | OPTIONAL, -- Need R |
| sl-UE-SelectedConfig-r16 | SL-UE-SelectedConfig-r16 |

OPTIONAL, -- Need R

| | |
|---|---|
| sl-NR-AnchorCarrierFreqList-r16 | SL-NR-AnchorCarrierFreqList-r16 |

OPTIONAL, -- Need R

| | |
|---|---|
| sl-EUTRA-AnchorCarrierFreqList-r16 | SL-EUTRA-AnchorCarrierFreqList-r16 |

OPTIONAL, -- Need R

| | |
|---|---|
| sl-RadioBearerConfigList-r16 | SEQUENCE (SIZE (1..maxNrofSLRB-r16)) OF |
| SL-RadioBearerConfig-r16 | OPTIONAL, -- Need R |
| sl-RLC-BearerConfigList-r16 | SEQUENCE (SIZE (1..maxSL-LCID-r16)) OF |
| SL-RLC-BearerConfig-r16 | OPTIONAL, -- Need R |
| sl-MeasConfigCommon-r16 | SL-MeasConfigCommon-r16 |

OPTIONAL, -- Need R

| | |
|---|---|
| sl-CSI-Acquisition-r16 | ENUMERATED {enabled} |

OPTIONAL, -- Need R

| | |
|---|---|
| sl-OffsetDFN-r16 | INTEGER (1..1000) |

OPTIONAL, -- Need R

| | |
|---|---|
| t400-r16 | ENUMERATED {ms100, ms200, ms300, ms400, ms600, |

ms1000, ms1500, ms2000} OPTIONAL, -- Need R

| | |
|---|---|
| sl-MaxNumConsecutiveDTX-r16 | ENUMERATED {n1, n2, n3, n4, n6, n8, n16, |
| n32} | OPTIONAL, -- Need R |
| sl-SSB-PriorityNR-r16 | INTEGER (1..8) |

OPTIONAL -- Need R
}
SL-NR-AnchorCarrierFreqList-r16 ::= SEQUENCE (SIZE (1..maxFreqSL-NR-r16))
OF ARFCN-ValueNR
SL-EUTRA-AnchorCarrierFreqList-r16 ::= SEQUENCE (SIZE (1..maxFreqSL-
EUTRA-r16)) OF ARFCN-ValueEUTRA
-- TAG-SIB12-STOP
-- ASN1STOP

The IE sl-CSI-Acquisition may represent whether CSI reporting is enabled in sidelink unicast. The IE sl-EUTRA-AnchorCarrierFreqList may represent the EUTRA anchor carrier frequency list. The IE sl-FreqInfoList may indicate sidelink communication configuration on some carrier frequency(ies). The IE sl-MaxNumConsecutiveDTX may represent the maximum number of consecutive HARQ DTX before triggering sidelink RLF. The IE sl-MeasConfigCommon may represent measurement configurations for sidelink communication. The IE sl-NR-AnchorCarrierFreqList may represent anchor carrier frequency list. The IE sl-OffsetDFN may represent the timing offset for the UE to determine direct frame number (DFN) timing when global navigation satellite system (GNSS) is used for timing reference. The IE sl-RadioBearerConfigList may represent one or multiple sidelink radio bearer configurations. The IE sl-RLC-BearerConfigList may represent one or multiple sidelink RLC bearer configurations. The IE sl-SSB-PriorityNR may represent the priority of sidelink SSB transmission and reception. The IE t400 may represent value for timer T400 associated with performing sidelink reconfiguration failure procedure. In some aspects, separate from the IE SL-ConfigCommonNR, an IE for sidelink positioning configuration may be provided and the sidelink positioning configuration may be provided separately from the sidelink data configuration.

In some aspects, the IE for sidelink positioning configuration may include one or more of: the IE sl-pos-FreqInfoList which may indicate sidelink positioning configuration on some carrier frequency(ies), the IE sl-MeasConfigCommon which may represent measurement configurations for sidelink communication for positioning, the IE sl-NR-pos-AnchorCarrierFreqList which may represent anchor carrier frequency list for positioning, the IE EUTRA-pos-AnchorCarrierFreqList which may represent the EUTRA anchor carrier frequency list for positioning, the IE sl-pos-OffsetDFN which may represent the timing offset for the UE to determine direct frame number (DFN) timing when global navigation satellite system (GNSS) is used for timing reference for positioning, a value for timer T400 associated with performing sidelink reconfiguration failure procedure for positioning, an IE sl-MeasConfigCommon which may represent the measurement configurations (AoA, AoD, reference signal received power (RSRP), or a reference signal time difference (RSTD), UE Rx-Tx, or the like) for sidelink positioning, an IE for gap configuration for positioning (e.g., which may identify gaps with no Tx/Rx that the UE may use for measurement related to positioning), or other IEs.

In some aspects, instead of SIB type 12, the SIB 806 may be of another SIB type, such as SIB type 12A dedicatedly configured for sidelink positioning (and not other sidelink communications). Another SIB of type 12 may be separately configured for the UE 802 for sidelink communications (e.g., that do not involve positioning).

FIG. 8B is a diagram 850 illustrating example communications between a network entity 854 and a UE 852. In some aspects, the network entity 854 may be implemented as an aggregated base station, a disaggregated base station, an integrated access and backhaul (IAB) node, a relay node, a sidelink node, or the like. In some aspects, the network entity 854 may be implemented in an aggregated or monolithic base station architecture, or alternatively, in a disaggregated base station architecture, and may include one or more of a CU, a DU, a RU, a Near-Real Time (Near-RT) RAN Intelligent Controller (RIC), or a Non-Real Time (Non-RT) RIC. Diagram 850 may illustrate a process for acquiring system information. As illustrated in FIG. 8B, the UE 852 may receive MIB 856 and then SIB 858 from the network entity 854. The UE 852 may accordingly transmit a system information request 860 to the network entity 854 and accordingly receive system information messages 862.

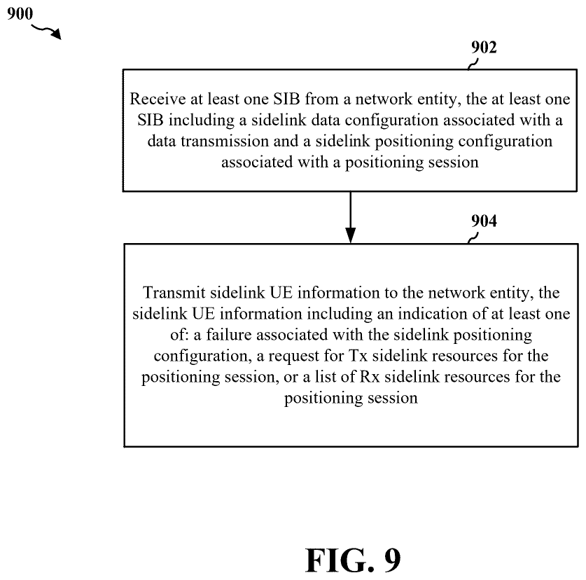

FIG. 9 is a flowchart 900 of a method of wireless communication. The method may be performed by a UE (e.g., the UE 104, the UE 802, the UE 852; the apparatus 1104).

At 902, the UE may receive at least one SIB from a network entity, the at least one SIB including a sidelink data configuration associated with a data transmission and a sidelink positioning configuration associated with a positioning session. For example, the UE 802 may receive at least one SIB (e.g., 806) from a network entity 804, the at least one SIB including a sidelink data configuration associated with a data transmission and a sidelink positioning configuration associated with a positioning session. In some aspects, 902 may be performed by SL component 198. In some aspects, the sidelink data configuration may be a same configuration as the sidelink positioning configuration. In some aspects, the sidelink data configuration may be different from the sidelink positioning configuration. In some aspects, the at least one SIB may be a SIB type 12 associated with a sidelink communication configuration. In some aspects, the SIB type 12 may be a SIB type 12a if the UE may be capable of sidelink positioning and configured by a set of upper layers to receive or transmit sidelink positioning. In some aspects, the sidelink positioning configuration may be represented by a first information element (IE) in the SIB type 12, and where the sidelink data configuration may be represented by a second IE in the SIB type 12. In some aspects, the first IE may include: a sidelink positioning frequency information list associated with the positioning session, a sidelink positioning selected configuration associated with the positioning session, a sidelink positioning anchor carrier frequency list associated with the positioning session, a sidelink positioning offset associated with the positioning session, a sidelink positioning measurement configuration associated with the positioning session, or a sidelink positioning gap configuration associated with the positioning session. In some aspects, the sidelink positioning measurement configuration may include one or more of: an angle of arrival (AoA), an angle of departure (AoD), a reference signal received power (RSRP), or a reference signal time difference (RSTD). In some aspects, the sidelink positioning gap configuration may be associated with one or more gaps with no transmission or reception.

At 904, the UE may transmit sidelink UE information to the network entity, the sidelink UE information including an indication of at least one of: a failure associated with the sidelink positioning configuration, a request for Tx sidelink resources for the positioning session, or a list of Rx sidelink resources for the positioning session. For example, the UE 802 may transmit sidelink UE information 808 to the network entity 804, the sidelink UE information including an indication of at least one of: a failure associated with the sidelink positioning configuration, a request for Tx sidelink resources for the positioning session, or a list of Rx sidelink resources for the positioning session. In some aspects, 904 may be performed by SL component 198. In some aspects, the sidelink UE information may include the request for the Tx sidelink resources for the positioning session and the list of the Rx sidelink resources for the positioning session. In some aspects, the failure associated with the sidelink positioning configuration may be independent of a failure associated with the sidelink data configuration. In some aspects, the list of Rx sidelink resources for the positioning session may be a list of interested Rx sidelink resources for the positioning session. In some aspects, the list of Rx sidelink resources may be in a priority order or the list of Rx sidelink resources may be associated with a priority tag.

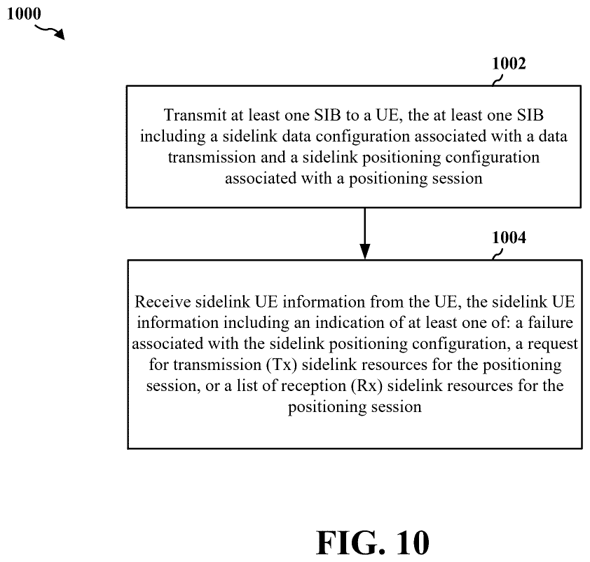

FIG. 10 is a flowchart 1000 of a method of wireless communication. The method may be performed by a network entity (e.g., the base station 102, the network entity 804, the network entity 854, the network entity 1102, the network entity 1202).

At 1002, the network entity may transmit at least one SIB to a UE, the at least one SIB including a sidelink data configuration associated with a data transmission and a sidelink positioning configuration associated with a positioning session. For example, the network entity 804 may transmit at least one SIB (e.g., 806) to a UE 802, the at least one SIB including a sidelink data configuration associated with a data transmission and a sidelink positioning configuration associated with a positioning session. In some aspects, 1002 may be performed by SL component 199. In some aspects, the sidelink data configuration may be a same configuration as the sidelink positioning configuration. In some aspects, the sidelink data configuration may be different from the sidelink positioning configuration. In some aspects, the at least one SIB may be a SIB type 12 associated with a sidelink communication configuration. In some aspects, the SIB type 12 may be a SIB type 12a if the UE may be capable of sidelink positioning and configured by a set of upper layers to receive or transmit sidelink positioning. In some aspects, the sidelink positioning configuration may be represented by a first information element (IE) in the SIB type 12, and where the sidelink data configuration may be represented by a second IE in the SIB type 12. In some aspects, the first IE may include: a sidelink positioning frequency information list associated with the positioning session, a sidelink positioning selected configuration associated with the positioning session, a sidelink positioning anchor carrier frequency list associated with the positioning session, a sidelink positioning offset associated with the positioning session, a sidelink positioning measurement configuration associated with the positioning session, or a sidelink positioning gap configuration associated with the positioning session. In some aspects, the sidelink positioning measurement configuration may include one or more of: an angle of arrival (AoA), an angle of departure (AoD), a reference signal received power (RSRP), or a reference signal time difference (RSTD). In some aspects, the sidelink positioning gap configuration may be associated with one or more gaps with no transmission or reception.

At 1004, the network entity may receive sidelink UE information from the UE, the sidelink UE information including an indication of at least one of: a failure associated with the sidelink positioning configuration, a request for Tx sidelink resources for the positioning session, or a list of Rx sidelink resources for the positioning session. For example, the network entity 804 may receive sidelink UE information 808 from the UE 802, the sidelink UE information including an indication of at least one of: a failure associated with the sidelink positioning configuration, a request for Tx sidelink resources for the positioning session, or a list of Rx sidelink resources for the positioning session. In some aspects, 1004 may be performed by SL component 199. In some aspects, the sidelink UE information may include the request for the Tx sidelink resources for the positioning session and the list of the Rx sidelink resources for the positioning session. In some aspects, the failure associated with the sidelink positioning configuration may be independent of a failure associated with the sidelink data configuration. In some aspects, the list of Rx sidelink resources for the positioning session may be a list of interested Rx sidelink resources for the positioning session. In some aspects, the list of Rx sidelink resources may be in a priority order or the list of Rx sidelink resources may be associated with a priority tag.

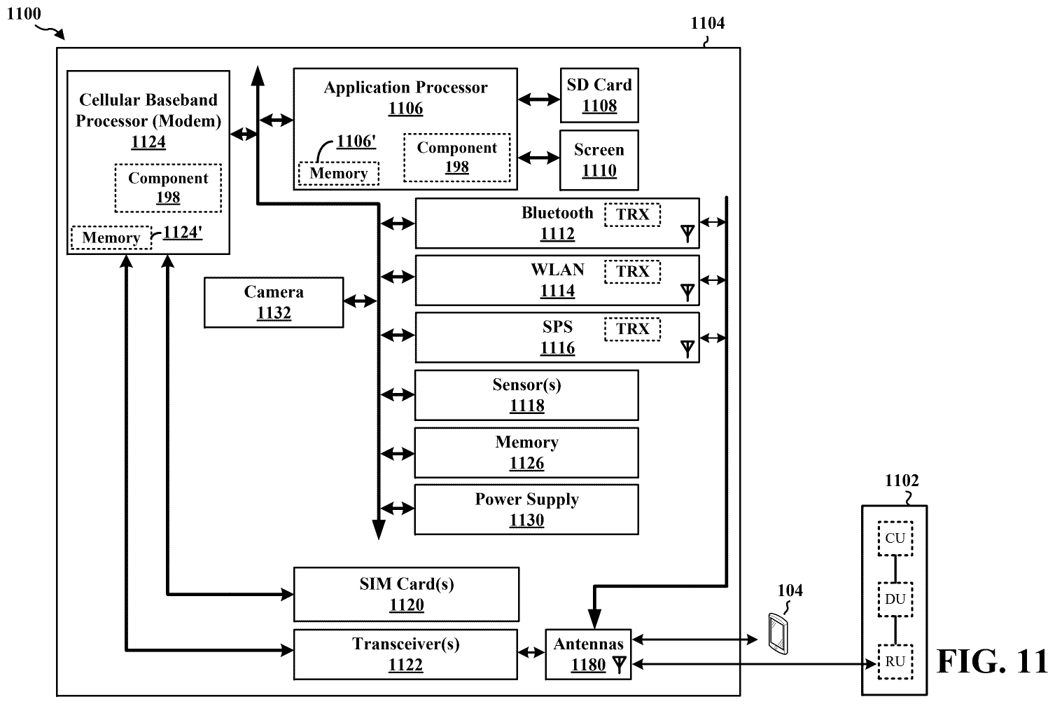

FIG. 11 is a diagram 1100 illustrating an example of a hardware implementation for an apparatus 1104. The apparatus 1104 may be a UE, a component of a UE, or may implement UE functionality. In some aspects, the apparatus 1104 may include a cellular baseband processor 1124 (also referred to as a modem) coupled to one or more transceivers 1122 (e.g., cellular RF transceiver). The cellular baseband processor 1124 may include on-chip memory 1124′. In some aspects, the apparatus 1104 may further include one or more subscriber identity modules (SIM) cards 1120 and an application processor 1106 coupled to a secure digital (SD) card 1108 and a screen 1110. The application processor 1106 may include on-chip memory 1106′. In some aspects, the apparatus 1104 may further include a Bluetooth module 1112, a WLAN module 1114, a satellite system module 1116 (e.g., GNSS module), one or more sensor modules 1118 (e.g., barometric pressure sensor/altimeter; motion sensor such as inertial management unit (IMU), gyroscope, and/or accelerometer(s); various types of ranging units, magnetometer, audio and/or other technologies used for positioning), additional memory modules 1126, a power supply 1130, and/or a camera 1132. The Bluetooth module 1112, the WLAN module 1114, and the satellite system module 1116 may include an on-chip transceiver (TRX)/receiver (RX). The cellular baseband processor 1124 communicates through the transceiver(s) 1122 via one or more antennas 1180 with the UE 104 and/or with an RU associated with a network entity 1102. The cellular baseband processor 1124 and the application processor 1106 may each include a computer-readable medium/memory 1124′, 1106′, respectively. The additional memory modules 1126 may also be considered a computer-readable medium/memory. Each computer-readable medium/memory 1124′, 1106′, 1126 may be non-transitory. The cellular baseband processor 1124 and the application processor 1106 are each responsible for general processing, including the execution of software stored on the computer-readable medium/memory. The software, when executed by the cellular baseband processor 1124/application processor 1106, causes the cellular baseband processor 1124/application processor 1106 to perform the various functions described herein. The computer-readable medium/memory may also be used for storing data that is manipulated by the cellular baseband processor 1124/application processor 1106 when executing software. The cellular baseband processor 1124/application processor 1106 may be a component of the UE 350 and may include the memory 360 and/or at least one of the TX processor 368, the RX processor 356, and the controller/processor 359. In one configuration, the apparatus 1104 may be a processor chip (modem and/or application) and include just the cellular baseband processor 1124 and/or the application processor 1106, and in another configuration, the apparatus 1104 may be the entire UE (e.g., see 350 of FIG. 3) and include the additional modules of the apparatus 1104.

As discussed herein, the SL component 198 may be configured to receive at least one system information block (SIB) from a network entity, the at least one SIB including a sidelink data configuration associated with a data transmission and a sidelink positioning configuration associated with a positioning session. In some aspects, the SL component 198 may be further configured to transmit sidelink UE information to the network entity, the sidelink UE information including an indication of at least one of: a failure associated with the sidelink positioning configuration, a request for transmission (Tx) sidelink resources for the positioning session, or a list of reception (Rx) sidelink resources for the positioning session. The SL component 198 may be within the cellular baseband processor 1124, the application processor 1106, or both the cellular baseband processor 1124 and the application processor 1106. The SL component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1104 may include a variety of components configured for various functions. In one configuration, the apparatus 1104, and in particular the cellular baseband processor 1124 and/or the application processor 1106, includes means for receiving at least one SIB from a network entity, the at least one SIB including a sidelink data configuration associated with a data transmission and a sidelink positioning configuration associated with a positioning session. In some aspects, the apparatus 1104 may further include means for transmitting sidelink UE information to the network entity, the sidelink UE information including an indication of at least one of: a failure associated with the sidelink positioning configuration, a request for Tx sidelink resources for the positioning session, or a list of Rx sidelink resources for the positioning session. The means may be the SL component 198 of the apparatus 1104 configured to perform the functions recited by the means. As described herein, the apparatus 1104 may include the TX processor 368, the RX processor 356, and the controller/processor 359. As such, in one configuration, the means may be the TX processor 368, the RX processor 356, and/or the controller/processor 359 configured to perform the functions recited by the means.

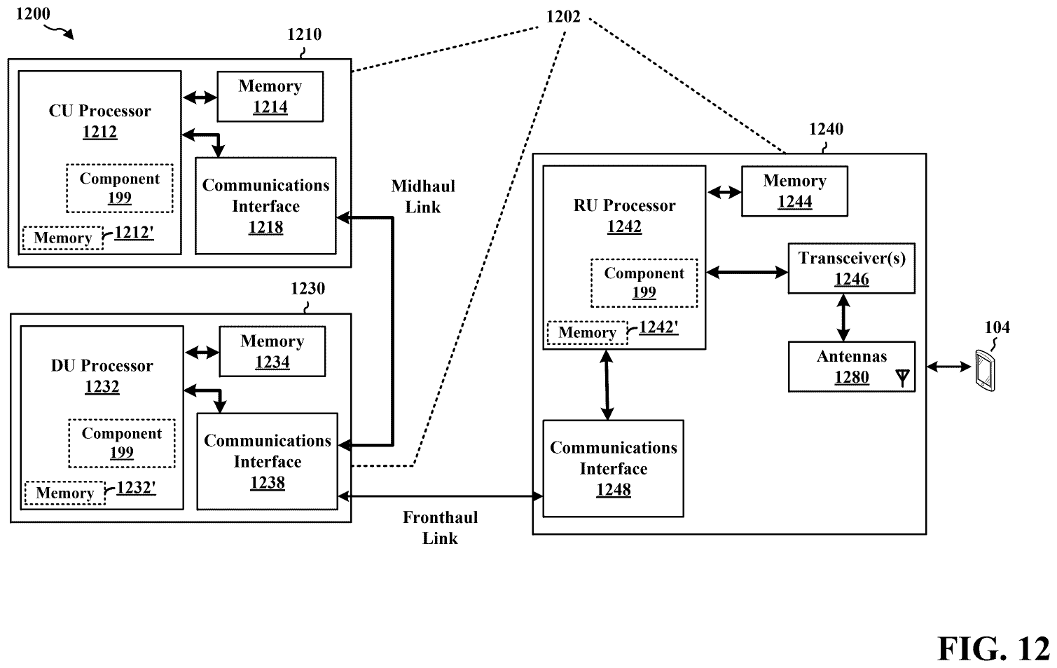

FIG. 12 is a diagram 1200 illustrating an example of a hardware implementation for a network entity 1202. The network entity 1202 may be a BS, a component of a BS, or may implement BS functionality. The network entity 1202 may include at least one of a CU 1210, a DU 1230, or an RU 1240. For example, depending on the layer functionality handled by the component 199, the network entity 1202 may include the CU 1210; both the CU 1210 and the DU 1230; each of the CU 1210, the DU 1230, and the RU 1240; the DU 1230; both the DU 1230 and the RU 1240; or the RU 1240. The CU 1210 may include a CU processor 1212. The CU processor 1212 may include on-chip memory 1212′. In some aspects, the CU 1210 may further include additional memory modules 1214 and a communications interface 1218. The CU 1210 communicates with the DU 1230 through a midhaul link, such as an F1 interface. The DU 1230 may include a DU processor 1232. The DU processor 1232 may include on-chip memory 1232′. In some aspects, the DU 1230 may further include additional memory modules 1234 and a communications interface 1238. The DU 1230 communicates with the RU 1240 through a fronthaul link. The RU 1240 may include an RU processor 1242. The RU processor 1242 may include on-chip memory 1242′. In some aspects, the RU 1240 may further include additional memory modules 1244, one or more transceivers 1246, antennas 1280, and a communications interface 1248. The RU 1240 communicates with the UE 104. The on-chip memory 1212′, 1232′, 1242′ and the additional memory modules 1214, 1234, 1244 may each be considered a computer-readable medium/memory. Each computer-readable medium/memory may be non-transitory. Each of the processors 1212, 1232, 1242 is responsible for general processing, including the execution of software stored on the computer-readable medium/memory. The software, when executed by the corresponding processor(s) causes the processor(s) to perform the various functions described herein. The computer-readable medium/memory may also be used for storing data that is manipulated by the processor(s) when executing software.

As discussed herein, the SL component 199 may be configured to transmit at least one system information block (SIB) to a user equipment (UE), the at least one SIB including a sidelink data configuration associated with a data transmission and a sidelink positioning configuration associated with a positioning session. In some aspects, the SL component 199 may be further configured to receive sidelink UE information from the UE, the sidelink UE information including an indication of at least one of: a failure associated with the sidelink positioning configuration, a request for transmission (Tx) sidelink resources for the positioning session, or a list of reception (Rx) sidelink resources for the positioning session. The SL component 199 may be within one or more processors of one or more of the CU 1210, DU 1230, and the RU 1240. The SL component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1202 may include a variety of components configured for various functions. In one configuration, the network entity 1202 includes means for transmitting at least one SIB to a UE, the at least one SIB including a sidelink data configuration associated with a data transmission and a sidelink positioning configuration associated with a positioning session. In some aspects, the network entity 1202 may further include means for receiving sidelink UE information from the UE, the sidelink UE information including an indication of at least one of: a failure associated with the sidelink positioning configuration, a request for Tx sidelink resources for the positioning session, or a list of Rx sidelink resources for the positioning session. The means may be the SL component 199 of the network entity 1202 configured to perform the functions recited by the means. As described herein, the network entity 1202 may include the TX processor 316, the RX processor 370, and the controller/processor 375. As such, in one configuration, the means may be the TX processor 316, the RX processor 370, and/or the controller/processor 375 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE, including: receiving at least one SIB from a network entity, the at least one SIB including a sidelink data configuration associated with a data transmission and a sidelink positioning configuration associated with a positioning session; and transmitting sidelink UE information to the network entity, the sidelink UE information including an indication of at least one of: a failure associated with the sidelink positioning configuration, a request for Tx sidelink resources for the positioning session, or a list of Rx sidelink resources for the positioning session.

Aspect 2 is the method of aspect 1, where the sidelink data configuration may be a same configuration as the sidelink positioning configuration.

Aspect 3 is the method of any of aspects 1-2, where the sidelink data configuration may be different from the sidelink positioning configuration.

Aspect 4 is the method of any of aspects 1-3, where the sidelink UE information may include the request for the Tx sidelink resources for the positioning session and the list of the Rx sidelink resources for the positioning session.

Aspect 5 is the method of any of aspects 1-4, where the at least one SIB may be a SIB type 12 associated with a sidelink communication configuration.

Aspect 6 is the method of any of aspects 1-5, where the SIB type 12 may be a SIB type 12a if the UE may be capable of sidelink positioning and configured by a set of upper layers to receive or transmit sidelink positioning.

Aspect 7 is the method of any of aspects 1-6, where the sidelink positioning configuration may be represented by a first information element (IE) in the SIB type 12, and where the sidelink data configuration may be represented by a second IE in the SIB type 12.

Aspect 8 is the method of any of aspects 1-7, where the first IE may include: a sidelink positioning frequency information list associated with the positioning session, a sidelink positioning selected configuration associated with the positioning session, a sidelink positioning anchor carrier frequency list associated with the positioning session, a sidelink positioning offset associated with the positioning session, a sidelink positioning measurement configuration associated with the positioning session, or a sidelink positioning gap configuration associated with the positioning session.

Aspect 9 is the method of any of aspects 1-8, where the sidelink positioning measurement configuration may include one or more of: an angle of arrival (AoA), an angle of departure (AoD), a reference signal received power (RSRP), or a reference signal time difference (RSTD)) or a UE Rx-Tx measurement.

Aspect 10 is the method of any of aspects 1-9, where the sidelink positioning gap configuration may be associated with one or more gaps with no transmission or reception.

Aspect 11 is the method of any of aspects 1-10, where the failure associated with the sidelink positioning configuration may be independent of a failure associated with the sidelink data configuration.

Aspect 12 is the method of any of aspects 1-11, where the list of Rx sidelink resources for the positioning session may be a list of interested Rx sidelink resources for the positioning session.

Aspect 13 is the method of any of aspects 1-13, where the list of Rx sidelink resources may be in a priority order or the list of Rx sidelink resources may be associated with a priority tag.

Aspect 14 is the method of any of aspects 1-13, where the method is performed at an apparatus including at least one processor and a memory. The apparatus may further include a transceiver or an antenna coupled to the at least one processor, and where the transceiver or the antenna may be configured to transmit the sidelink UE information.

Aspect 15 is a method of wireless communication at a network entity, including: transmitting at least one SIB to a UE, the at least one SIB including a sidelink data configuration associated with a data transmission and a sidelink positioning configuration associated with a positioning session; and receiving sidelink UE information from the UE, the sidelink UE information including an indication of at least one of: a failure associated with the sidelink positioning configuration, a request for Tx sidelink resources for the positioning session, or a list of Rx sidelink resources for the positioning session.

Aspect 16 is the method of aspect 15, where the sidelink data configuration may be a same configuration as the sidelink positioning configuration.

Aspect 17 is the method of any of aspects 15-16, where the sidelink data configuration may be different from the sidelink positioning configuration.

Aspect 18 is the method of any of aspects 15-17, where the sidelink UE information may include the request for the Tx sidelink resources for the positioning session and the list of the Rx sidelink resources for the positioning session.

Aspect 19 is the method of any of aspects 15-18, where the at least one SIB may be a SIB type 12 associated with a sidelink communication configuration.

Aspect 20 is the method of any of aspects 15-19, where the SIB type 12 may be a SIB type 12a if the UE may be capable of sidelink positioning and configured by a set of upper layers to receive or transmit sidelink positioning.

Aspect 21 is the method of any of aspects 15-20, where the sidelink positioning configuration may be represented by a first information element (IE) in the SIB type 12, and where the sidelink data configuration may be represented by a second IE in the SIB type 12.

Aspect 22 is the method of any of aspects 15-21, where the first IE may include: a sidelink positioning frequency information list associated with the positioning session, a sidelink positioning selected configuration associated with the positioning session, a sidelink positioning anchor carrier frequency list associated with the positioning session, a sidelink positioning offset associated with the positioning session, a sidelink positioning measurement configuration associated with the positioning session, or a sidelink positioning gap configuration associated with the positioning session.

Aspect 23 is the method of any of aspects 15-22, where the sidelink positioning measurement configuration may include one or more of: an angle of arrival (AoA), an angle of departure (AoD), a reference signal received power (RSRP), or a reference signal time difference (RSTD) or a UE Rx-Tx measurement.

Aspect 24 is the method of any of aspects 15-23, where the sidelink positioning gap configuration may be associated with one or more gaps with no transmission or reception.

Aspect 25 is the method of any of aspects 15-24, where the failure associated with the sidelink positioning configuration may be independent of a failure associated with the sidelink data configuration.

Aspect 26 is the method of any of aspects 15-25, where the list of Rx sidelink resources for the positioning session may be a list of interested Rx sidelink resources for the positioning session.

Aspect 27 is the method of any of aspects 15-26, where the list of Rx sidelink resources may be in a priority order or the list of Rx sidelink resources may be associated with a priority tag.

Aspect 28 is the method of any of aspects 15-27, where the method is performed at an apparatus including at least one processor and a memory. The apparatus may further include a transceiver or an antenna coupled to the at least one processor, and where the transceiver or the antenna may be configured to transmit the sidelink UE information.

Aspect 29 is an apparatus for wireless communication at a device including a memory and at least one processor coupled to the memory and, based at least in part on information stored in the memory, configured to perform a method in accordance with any of aspects 1-14. The apparatus may include at least one of a transceiver or an antenna coupled to the at least one processor.

Aspect 30 is an apparatus for wireless communication, including means for performing a method in accordance with any of aspects 1-14.

Aspect 31 is a non-transitory computer-readable medium including instructions that, when executed by an apparatus, cause the apparatus to perform a method in accordance with any of aspects 1-14.

Aspect 32 is an apparatus for wireless communication at a device including a memory and at least one processor coupled to the memory and, based at least in part on information stored in the memory, configured to perform a method in accordance with any of aspects 15-28. The apparatus may include at least one of a transceiver or an antenna coupled to the at least one processor.

Aspect 33 is an apparatus for wireless communication, including means for performing a method in accordance with any of aspects 15-28.

Aspect 34 is a non-transitory computer-readable medium including instructions that, when executed by an apparatus, cause the apparatus to perform a method in accordance with any of aspects 15-28.

What is claimed is:

1. An apparatus for wireless communication at a user equipment (UE), comprising:
a memory; and
at least one processor coupled to the memory, wherein the at least one processor is configured to:
receive at least one system information block (SIB) from a network entity, the at least one SIB including a sidelink data configuration associated with a data transmission and a sidelink positioning configuration associated with a positioning session; and
transmit sidelink UE information to the network entity, the sidelink UE information including an indication of at least one of: a failure associated with the sidelink positioning configuration, a request for transmission (Tx) sidelink resources for the positioning session, or a list of reception (Rx) sidelink resources for the positioning session.

2. The apparatus of claim 1, wherein the sidelink data configuration is a same configuration as the sidelink positioning configuration.

3. The apparatus of claim 1, wherein the sidelink data configuration is different from the sidelink positioning configuration.

4. The apparatus of claim 1, wherein the sidelink UE information comprises the request for the Tx sidelink resources for the positioning session and the list of the Rx sidelink resources for the positioning session.

5. The apparatus of claim 1, wherein the at least one SIB is a system information block (SIB) type 12 associated with a sidelink communication configuration.

6. The apparatus of claim 5, wherein the SIB type 12 is a SIB type 12a if the UE is capable of sidelink positioning and configured by a set of upper layers to receive or transmit sidelink positioning.

7. The apparatus of claim 5, wherein the sidelink positioning configuration is represented by a first information element (IE) in the SIB type 12, and wherein the sidelink data configuration is represented by a second IE in the SIB type 12.

8. The apparatus of claim 7, wherein the first IE comprises: a sidelink positioning frequency information list associated with the positioning session, a sidelink positioning selected configuration associated with the positioning session, a sidelink positioning anchor carrier frequency list associated with the positioning session, a sidelink positioning offset associated with the positioning session, a sidelink positioning measurement configuration associated with the positioning session, or a sidelink positioning gap configuration associated with the positioning session.

9. The apparatus of claim 8, wherein the sidelink positioning measurement configuration comprises one or more of: an angle of arrival (AoA), an angle of departure (AoD), a reference signal received power (RSRP), or a reference signal time difference (RSTD) or a UE Rx-Tx measurement.

10. The apparatus of claim 8, wherein the sidelink positioning gap configuration is associated with one or more gaps with no transmission or reception.

11. The apparatus of claim 1, wherein the failure associated with the sidelink positioning configuration is independent of a failure associated with the sidelink data configuration.

12. The apparatus of claim 1, wherein the list of Rx sidelink resources for the positioning session is a list of interested Rx sidelink resources for the positioning session.

13. The apparatus of claim 1, wherein the list of Rx sidelink resources is in a priority order or the list of Rx sidelink resources is associated with a priority tag.

14. The apparatus of claim 1, further comprising a transceiver or an antenna coupled to the at least one processor, and wherein the transceiver or the antenna is configured to transmit the sidelink UE information.

15. An apparatus for wireless communication at a network entity, comprising:
a memory; and
at least one processor coupled to the memory, wherein the at least one processor is configured to:
transmit at least one system information block (SIB) to a user equipment (UE), the at least one SIB including a sidelink data configuration associated with a data transmission and a sidelink positioning configuration associated with a positioning session; and
receive sidelink UE information from the UE, the sidelink UE information including an indication of at least one of: a failure associated with the sidelink positioning configuration, a request for transmission (Tx) sidelink resources for the positioning session, or a list of reception (Rx) sidelink resources for the positioning session.

16. The apparatus of claim 15, wherein the sidelink data configuration is a same configuration as the sidelink positioning configuration.

17. The apparatus of claim 15, wherein the sidelink data configuration is different from the sidelink positioning configuration.

18. The apparatus of claim 15, wherein the sidelink UE information comprises the request for the Tx sidelink resources for the positioning session and the list of the Rx sidelink resources for the positioning session.

19. The apparatus of claim 15, wherein the at least one SIB is a system information block (SIB) type 12 associated with a sidelink communication configuration.

20. The apparatus of claim 19, wherein the SIB type 12 is a SIB type 12a if the UE is capable of sidelink positioning and configured by a set of upper layers to receive or transmit sidelink positioning.

21. The apparatus of claim 19, wherein the sidelink positioning configuration is represented by a first information element (IE) in the SIB type 12, and wherein the sidelink data configuration is represented by a second IE in the SIB type 12.

22. The apparatus of claim 21, wherein the first IE comprises: a sidelink positioning frequency information list associated with the positioning session, a sidelink positioning selected configuration associated with the positioning session, a sidelink positioning anchor carrier frequency list associated with the positioning session, a sidelink positioning offset associated with the positioning session, a sidelink positioning measurement configuration associated with the positioning session, or a sidelink positioning gap configuration associated with the positioning session.

23. The apparatus of claim 22, wherein the sidelink positioning measurement configuration comprises one or more of: an angle of arrival (AoA), an angle of departure (AoD), a reference signal received power (RSRP), or a reference signal time difference (RSTD) or a UE Rx-Tx measurement.

24. The apparatus of claim 22, wherein the sidelink positioning gap configuration is associated with one or more gaps with no transmission or reception.

25. The apparatus of claim 15, wherein the failure associated with the sidelink positioning configuration is independent of a failure associated with the sidelink data configuration.

26. The apparatus of claim 15, wherein the list of Rx sidelink resources for the positioning session is a list of interested Rx sidelink resources for the positioning session.

27. The apparatus of claim 15, wherein the list of Rx sidelink resources is in a priority order or the list of Rx sidelink resources is associated with a priority tag.

28. The apparatus of claim 15, further comprising a transceiver or an antenna coupled to the at least one processor, and wherein the transceiver or the antenna is configured to receive the sidelink UE information.

29. A method of wireless communication at a user equipment (UE), comprising:
receiving at least one system information block (SIB) from a network entity, the at least one SIB including a sidelink data configuration associated with a data transmission and a sidelink positioning configuration associated with a positioning session; and
transmitting sidelink UE information to the network entity, the sidelink UE information including an indication of at least one of: a failure associated with the sidelink positioning configuration, a request for transmission (Tx) sidelink resources for the positioning session, or a list of reception (Rx) sidelink resources for the positioning session.

30. A method of wireless communication at a network entity, comprising:
transmitting at least one system information block (SIB) to a user equipment (UE), the at least one SIB including a sidelink data configuration associated with a data transmission and a sidelink positioning configuration associated with a positioning session; and
receiving sidelink UE information from the UE, the sidelink UE information including an indication of at least one of: a failure associated with the sidelink positioning configuration, a request for transmission (Tx) sidelink resources for the positioning session, or a list of reception (Rx) sidelink resources for the positioning session.
